(19) United States
(12) Patent Application Publication
(10) Pub. No.: US 2018/0347634 A1
(43) Pub. Date: Dec. 6, 2018

(54) ASSEMBLY WITH A PLUG CONNECTION

(71) Applicant: Miba Sinter Austria GmbH, Laakirchen (AT)

(72) Inventors: David JOCHER, Ebensee (AT); Martin OHLER, Vorchdorf (AT); Horst ROESSLER, Krenglbach (AT); Wolfgang SCHIMPL, Scharnstein (AT)

(73) Assignee: Miba Sinter Austria GmbH, Laakirchen (AT)

(21) Appl. No.: 15/955,786

(22) Filed: Apr. 18, 2018

(30) Foreign Application Priority Data
May 30, 2017 (AT) A 50452/2017

(51) Int. Cl. F16D 1/08; F16H 55/17; F16H 55/22

(52) U.S. Cl. CPC F16D 1/0852; F16H 2055/176; F16H 55/22; F16H 55/17

(57) ABSTRACT

The invention relates to an assembly (1) comprising a first component (2) with an internal toothing (4) and a second component (3) with an external toothing (6), wherein the two components (2, 3) can be connected to one another by a press fit, which is formed between the internal and the external toothing (4, 6), and wherein the internal and the external toothing (4, 6) each comprise a plurality of teeth (5, 7). The teeth (5) of the internal toothing (4) of the first component (2) and/or the teeth (7) of the external toothing (6) of the second component (3) comprise recesses (13, 15) along the tooth flanks (12, 14).

The invention relates to an assembly comprising a first component with an internal toothing and a second component with an external toothing, wherein the two components can be connected together by a press fit, which is formed between the internal and the external toothing, and wherein the internal and the external toothing each have a plurality of teeth.

The invention also relates to a synchronizer hub with a hub body, in which an opening is formed which is delimited by an internal toothing with teeth.

The invention also relates to a method for producing a plug connection with a press fit between a first component comprising an internal toothing and a second component comprising an external toothing, wherein the internal toothing and the external toothing are both produced with teeth.

Plug connections for connecting two components and for transmitting torques between the components have been known for a long time. There are many different embodiment variants, depending on whether only a form fit is needed or whether also a press fit is required, i.e. a press hold. In the latter case the profiles of the toothings are produced with an overlap. For this purpose the teeth of the external toothing are produced to have a larger cross-sectional area (as viewed in axial direction) than the tooth gaps of the internal toothing. Thus for connecting the two components suitably high forces have to be applied. In addition, when connecting the two components to one another, as a consequence of the press fit in the area of the teeth of the toothings, a very high degree of tension is achieved which exceeds the stress limit with regard to the fatigue strength of the material in many applications. It has previously barely been possible to reduce the level of tension due to the necessity of avoiding fretting corrosion and due to the tolerance spectrum in worst case pairings of largest shaft and smallest hub for example.

The objective of the invention is to make it possible to connect two components by means of a plug connection with improved fatigue strength.

The objective of the invention is achieved in the aforementioned assembly in that the teeth of the internal toothing of the first component and/or the teeth of the external toothing of the second component have recesses along the tooth flanks.

Furthermore, the objective of the invention is achieved by means of the aforementioned synchronizer hub, in which recesses are formed in the flanks of the teeth.

In addition, the objective of the invention is achieved by means of the aforementioned method, according to which the tooth flanks of each of the teeth of the external toothing of the second component and/or of each of the teeth of the internal toothing of the first component are produced partly with an overlap with the respective other teeth of the internal toothing or the external toothing and partly with play between the teeth of the internal toothing and the external toothing.

It is an advantage here that by means of the tooth geometry with the recess the level of stress in the toothings of the plug connection can be reduced significantly. In this way the overlap for forming the press fit can be displaced from the critical area, whereby the stress of the material per se can be reduced. This can be applied in turn to use a less expensive material concept for the same application, as the material no longer has to be selected to correspond with the high tension level.

According to one embodiment variant of the invention it is possible to form recesses in areas of the tooth flanks adjoining the bases of the teeth. In a continuation of the aforementioned embodiment variant of the assembly by means of this embodiment variant the usually critical point of the tooth base can also be take into consideration, thereby avoiding material fatigue and thus material breakage more effectively.

In order to improve the aforementioned effects and thus the assembly with regard to its fatigue strength, according to a further embodiment variant it is possible for further recesses to be formed in the tooth bases and/or in the tooth heads.

Preferably, the recesses extend into the tooth flanks to a tooth height selected from a range of 20% to 70% of the whole tooth height, measured starting from the tooth bases. Particularly with recesses in this area it could be established that a sufficient press fit can be ensured for the transmission of torque, and at the same time there is a very low level of tension in the connection between the two components.

According to another embodiment variant of the assembly to simplify the production of the teeth it is possible that the recesses form a common recess respectively in the tooth flanks together with additional recesses in the tooth bases.

In particular, in this case however and also in general, it is possible that in the recesses the teeth of the external toothing fit into the tooth gaps of the internal toothing in the area of the tooth heads respectively only with the transitional areas of the tooth flanks to the tooth heads fitting against the tooth flanks of the internal toothing. In this way the connection between the two components can be improved despite the low level of tension in the toothings.

For a better understanding of the invention the latter is explained in more detail with reference to the following figures.

In a simplified, schematic representation:

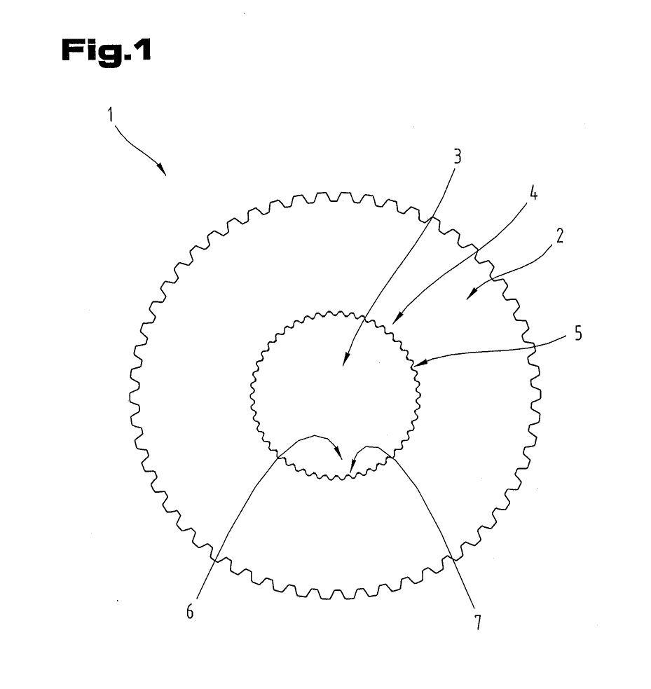

FIG. 1 shows an assembly in front view;

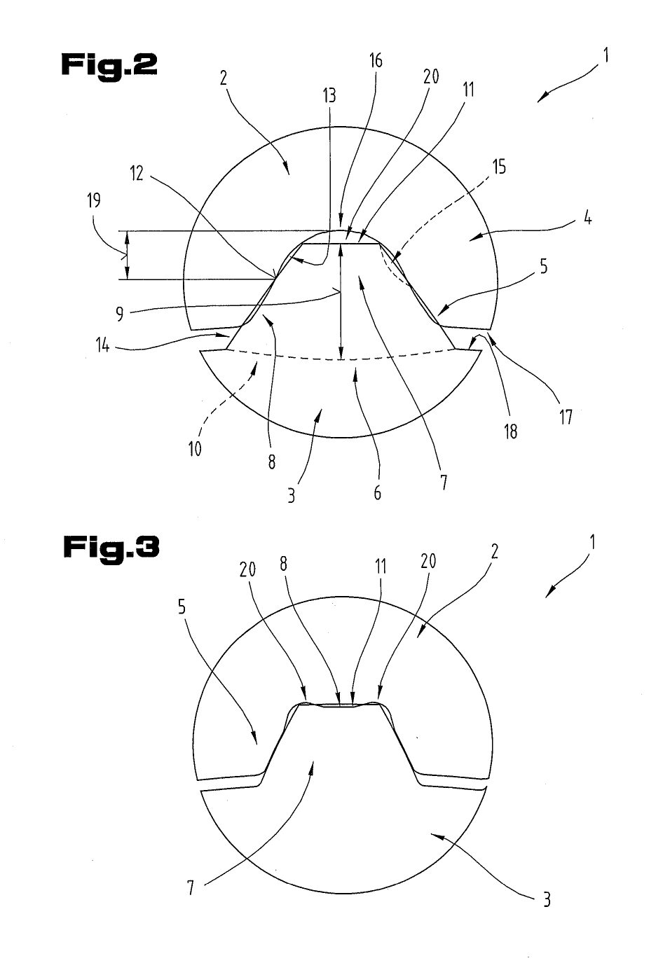

FIG. 2 shows a cut-out of an assembly;

FIG. 3 shows a cut-out of an assembly according to one embodiment variant.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

FIG. 1 shows an assembly 1 viewed in axial direction. The assembly 1 comprises a first component 2 and a second component 3. The first component 2 is connected to the second component 3 by means of a plug connection. For this purpose the first component 2 comprises an internal toothing 4 with teeth 5 and the second component 3 comprises an external toothing 6 with teeth 7. The teeth 5 of the internal toothing 4 and the teeth 7 of the external toothing 6 can be designed to adjoin one another directly in circumferential direction, as shown in FIG. 1. However, it is also possible to space apart the teeth 5 of the internal toothing 4 and the teeth 7 of the external toothing 6 respectively in circumferential direction. The example of the assembly 1 shown specifically in FIG. 1 is therefore only given by way of example at least in relation to the geometry and/or the arrangement of the teeth of the internal toothing 4 and the teeth 7 of the external toothing 6.

In principle, such assemblies in which two component are connected to one another by means of plug connections for the transmission of torque are known from the prior art. Therefore, in the following description this general aspect of the assembly 1 is not discussed further. A person skilled in the art is referred here to the relevant prior art.

The component 2 shown in FIG. 1 is in particular a synchronizer hub. The component 3 is thus a shaft. Although this is the preferred embodiment of the assembly 1, it is also possible within the scope of the invention for the components 2, 3 to be designed differently as long are they are joined together by means of a plug connection.

To connect the two components 2, 3 together a press fit is formed between the internal toothing 4 of the component 2 and the external toothing 6 of the component 3. This is achieved in that the internal toothing 4 of the component 2 comprises an overlapping area 8 to the external toothing 6 of the component 3, as shown in FIG. 2, which shows a cut-out from an embodiment variant of the assembly 1. The overlapping area 8 is formed in that the width of the teeth 5 of the internal toothing 4 in circumferential direction of the assembly 1 is greater than the corresponding width of the tooth gaps between the teeth 7 of the external toothing 6 in said overlapping area and as viewed in the same direction at the same radial height. However, also a reverse embodiment is also possible in that the teeth 5 of the internal toothing 4 have at least almost the nominal dimensions and the tooth gaps between the teeth 7 of the external toothing 6 are smaller.

Here this overlapping area 8 of the teeth 5 of the internal toothing 4 with the teeth 7 of the external toothing 6 does not extend over the whole tooth height 9 in radial direction.

The tooth height 9 is the dimension of the teeth 7 of the external toothing 6 between a tooth base diameter 10 and a tooth head 11.

The same also applies to the tooth height of the teeth 5 of the internal toothing 4.

In general it should be noted that the terms “tooth base”, “tooth flank”, “tooth head”, “tooth base diameter”, etc. are used according to the definition in DIN 3998 in the applicable version valid on the application date of the present application.

In order that the overlapping area 8 does not extend over the whole tooth height 9 the teeth 5 of the internal toothing 4 of the first component 2 have recesses 13 along the tooth flanks 12. In particular, only one recess 13 is provided for each tooth flank 12 of the teeth 5 of the internal toothing.

Alternatively or in addition, it is also possible that to reduce the length of the overlapping area 8 the teeth 7 of the external toothing 6 of the second component 3 have recesses 15 along tooth flanks 14, as indicated by dashed lines in FIG. 2.

The tooth flanks 12 and/or the tooth flanks 14 can have an approximately S-shaped contour between the tooth bases 16 and the tooth heads 17 and/or between the tooth bases 18 and the tooth heads 11 for example as viewed in axial direction (corresponds to the direction of the plane of FIG. 2). The recesses 13 and/or recesses 15 can be designed to be trough-liked in cross-section, as shown in FIG. 2. They can thus have a deeper central area which is flat in the side areas.

Preferably, the recesses 13 and/or the recesses 15 extend over the whole width of the teeth 5 or teeth 7 in axial direction. They thus extend into the end faces of the teeth 5 or teeth 7.

Although the contour of the tooth flanks 12 and/or the tooth flanks 14 shown in FIG. 2 is the preferred contour, as this geometry can be achieved more easily by means of sintering technology (preferably at least one of the components 2, 3 of the assembly is produced by a sintering method), the recesses 13 and/or recesses 15 can also have a different cross-sectional geometry. For example the latter can be designed to be rectangular or quadratic or triangular, etc.

Preferably, the external toothing 6 of the component 3 is designed as an involute toothing. The internal toothing of the component 3 has a tooth gap with a noncomplementary form, i.e. the tooth gaps have a larger cross-sectional area defined by the recesses 13 than the teeth 7 of the external toothing 6. A press fit, i.e. a press hold, is only formed between the toothings in the overlapping area 8 of the teeth 5. The overlap can be between 10 μm and 50 μm.

The tooth flanks 12 of the teeth 7 of the external toothing 6 of the component 3 thus only partly bear on the tooth flanks 14 of the teeth 5 of the internal toothing 4 of the component 2.

However, it is possible, particularly if at least one of the two components 2, 3 is a sintered component, that when sliding component 3 onto component 2 material is displaced by deformation into the recesses 13 and/or the recesses 15.

According to a preferred embodiment variant of the assembly 1 and the corresponding component 2 or 3 the recesses 13 can be formed in areas adjoining the tooth base 16 of the teeth 5 of the component 2, in particular directly adjoining areas, of the tooth flanks 12, as shown in FIG. 2. This applies similarly to the recesses 15.

It is also possible however to form the recesses 13 spaced apart from the tooth bases 16 of the teeth 5 of the component 2 starting in the tooth flanks 12. The distance from the tooth bases 16 can be between 2% and 10% of the tooth height 9. This can apply similarly to the recesses 15.

Generally the recesses 13 in the tooth flanks 12 can extend to a height 19 of the teeth 5, which is selected from a range of 20% to 70%, in particular from a range of 30% to 50% of the whole tooth height 9, as measured starting from the tooth bases 16. This can apply similarly to the recesses 15.

According to another embodiment variant of the assembly 1, a section of which is shown in FIG. 3, additional recesses 20 are formed in the tooth heads 11. This can apply similarly to the tooth heads 17.

Said additional recesses 20 can be formed in the transitional area from the tooth flank 14 to the tooth head 11, in particular in both transitional areas of a tooth 7. The overlapping area 8 can be formed between the two additional recesses 20. This can apply similarly to the tooth heads 17.

However, it is also possible that the additional recesses are formed in the tooth bases 16 of the internal toothing 4 of the component 2, as shown in FIG. 2. This can apply similarly to the tooth bases 18 of the teeth 7 of the external toothing 6.

Thus according to another preferred embodiment variant of the assembly 1 shown in FIG. 2 the recesses 13 in the tooth flanks 12 together with the additional recesses 20 in the tooth bases 16 form a common recess respectively. Said common recess can have an at least approximately semi-circular cross-section for example, as shown in FIG. 2.

According to another embodiment variant of the assembly 1 it is possible that in said common recesses the teeth 7 of the external toothing 6 fit into the tooth gaps of the internal toothing 4 in the area of the tooth heads 11 respectively only with the transitional areas of the tooth flanks 14 to the tooth heads 11 against the tooth flanks 12 of the internal toothing 4, as also shown in FIG. 2. It is thus possible that in the area of said common recesses the teeth 7 only bear with their edges between the tooth flanks 14 and the tooth heads 11 on the tooth flanks 12 of the teeth 5 of the internal toothing 4.

As already explained the component 2 in the preferred embodiment variant is a synchronizer hub. The latter comprises a hub body in which an opening is formed which is delimited by the internal toothing 4 with teeth 5. Said internal toothing 4 is designed in the aforementioned manner, in particular with the recesses 13 in the tooth flanks 12.

The invention also relates to a method for producing a plug connection with a press fit (press hold) between the first component 2 comprising the internal toothing 4 and the second component 3 comprising the external toothing 6, wherein the internal toothing 4 and the external toothing 6 are produced respectively with teeth 5, 7. The tooth flanks 14 of each of the teeth 7 of the external toothing 6 of the second component 3 and/or the tooth flanks 12 of each of the teeth 5 of the internal toothing 4 of the first component 2 are produced in the overlapping area 8 with an overlap with the other respective teeth 5, 7 of the internal toothing 4 or the external toothing 5 and partially with play between the teeth 5, 7 of the internal toothing 4 and the external toothing 6. This play is achieved as described above with the recesses 13 and/or the recesses 15 and/or the additional recesses 20 and/or the described common recesses.

Thus each tooth 5, 7 of the toothings comprises the overlap and play.

However, it is also possible not to design all of the teeth 5, 7 in this way. For example only every second or every third or every fourth tooth 5, 7 can comprise the overlap and the play. Likewise it is also possible that only four or only five or only six or only seven or only eight etc. teeth 5, 7 comprise the overlap and the play.

The invention makes use in particular of a special tooth gap form, in order to thus reduce the level of tension in the press fit. In this way the fatigue strength of the press fit can be improved. It has been found in measurements that the level of tension in the toothings can be reduced by at least 10%, compared with a press fit of toothings over the whole length of the tooth flanks, i.e. without the free spaces in the form of recesses.

The embodiments show possible embodiment variants, wherein it should be noted at this point that combinations of the individual embodiment variants are also possible.

Lastly, as a point of formality it should be noted that for a better understanding of the structure of the assembly 1 the latter is not necessarily true to scale.

### LIST OF REFERENCE NUMERALS

1 assembly
2 component
3 component
4 internal toothing
5 tooth
6 external toothing
7 tooth
8 overlapping area
9 tooth height
10 tooth base diameter
11 tooth head
12 tooth flank
13 recess
14 tooth flank
15 recess
16 tooth base
17 tooth head
18 tooth base
19 height
20 recess

1. An assembly (1) comprising a first component (2) with an internal toothing (4) and a second component (3) with an external toothing (6), wherein the two components (2, 3) are connected to one another by a press fit, which is formed between the internal and the external toothing (4, 6), and wherein the internal and the external toothing (4, 6) each comprise a plurality of teeth (5, 7), wherein the teeth (5) of the internal toothing (4) of the first component (2) and/or the teeth (7) of the external toothing (6) of the second component (3) have recesses (13, 15) along the tooth flanks (12, 14).

2. The assembly (1) as claimed in claim 1, wherein the recesses (13, 15) are formed in areas of the tooth flanks (12) adjoining the tooth bases (16).

3. The assembly (1) as claimed in claim 1, wherein further recesses (20) are formed in the tooth bases (16) and/or in the tooth heads (11).

4. The assembly (1) as claimed in claim 1, wherein the recesses (13, 15) in the tooth flanks (12, 14) extend up to a height (19) of the teeth (5, 7) selected from a range of 20% to 70% of the whole tooth height (9), as measured starting from the tooth bases (16).

5. The assembly (1) as claimed in claim 3, wherein the recesses (13) in the tooth flanks (12) together with the additional recesses (20) in the tooth bases (16) form a common recess respectively.

6. The assembly (1) as claimed in claim 1, wherein in the recesses the teeth (7) of the external toothing (6) fit in the tooth gaps of the internal toothing (4) in the area of the tooth heads (11) respectively only with the transitional areas of the tooth flanks (14) to the tooth heads (11) fitting against the tooth flanks (12) of the internal toothing (4).

7. A synchronizer hub comprising a hub body, in which an opening is formed which is delimited by an internal toothing (4) with teeth (5), wherein recesses (13) are formed in the tooth flanks (12) of the teeth (5).

8. A method for producing a plug connection with a press fit between a first component (2) comprising an internal toothing (4) and a second component (3) comprising an external toothing (6), wherein the internal toothing (4) and the external toothing (6) are produced respectively with teeth (5, 7), wherein the tooth flanks (14) of each of the teeth (7) of the external toothing (6) of the second component (3) and/or each of the teeth (5) of the internal toothing (4) of the first component (2) are produced partly with an overlap to the respective other teeth (5, 7) of the internal toothing (4) or the external toothing (6) and partly with play between the teeth (5, 7) of the internal toothing (4) and the external toothing (6).
